(19) United States
(12) Patent Application Publication
(10) Pub. No.: US 2009/0133302 A1
(43) Pub. Date: May 28, 2009

(54) LED-ILLUMINATED SIGN

(75) Inventors: KIMLONG HUYNH, SANTA ANA, CA (US); GIAO LE, WESTMINSTER, CO (US)

Correspondence Address: J C PATENTS, INC., 4 VENTURE, SUITE 250, IRVINE, CA, 92618, US

(73) Assignee: LITE STYLE ELECTRONICS, LLC, FOUNTAIN VALLEY, CA (US)

(21) Appl. No.: 11/945,843

(22) Filed: Nov. 27, 2007

(51) Int. Cl. G09F 13/04

(52) U.S. Cl. 40/564

(57) ABSTRACT

An illuminated sign comprises two or more panels and a frame. The frame is positioned between the panels, so that the frame and the panels form a housing. A pattern made of a colored material, a light scattering material, a light reflecting material, or a combination of the above in various color is coupled to at least one of the panels and positioned inside the housing. LEDs are placed inside the housing to illuminate the pattern. The panels are made of transparent material. The frame can be an integral part of the front and rear panel.

### BACKGROUND OF THE INVENTION

1. Field of the Invention

The present invention relates generally to an illuminated sign for indoor or outdoor use, and more particularly, to an illuminated sign in which light emitting diodes (LEDs) are used as the source of illumination illuminating on a pattern to be displayed made of a light scattering/reflecting material.

2. Description of Related Art

There are many types and varieties of illuminated signs, some of which have translucent panels with an opaque message with a background which is illuminated by lamps from behind. Others are just opposite wherein light from lamps on the inside shine through transparent or translucent letters or numerals. Some are painted signs illuminated from the front from above or below. One common type of sign is referred to as a box sign because it is in the form of a box with lamps, either inside or on the outside directed toward a front panel carrying its message. But, these box signs usually are bulky and expensive to manufacture.

### SUMMARY OF THE INVENTION

The present invention is directed to an illuminated sign which has a housing formed by a frame and two or more panels. The housing defines an enclosed space for accommodating a light source and a pattern. The panels face each other forming a front wall and a rear wall of the housing, the frame is connected to the panels at their edges to from the sidewalls of the housing. The housing does not have to be sealed. But, if desired, the housing can be sealed against dust and insects such spiders. It also can be sealed against moisture. Preferably, the panels are made of transparent material so that the illuminated sign has a transparent structure and can be seen through. The pattern can be a letter, a symbol, a logo, a figure, or a combination of the above, and is made of colored material, light scattering material, or light reflecting material, such as reflecting acrylic material or neon acrylic material, polycarbonate, ABS, nylon, polystyrene, or any suitable plastic alloy such as polyethylene, polypropylene, polyvinyl chloride, and polyethylene terephthalate, or a combination of the above, in various color or with no color. To enhance the light scattering effects, the reflecting surface of the pattern can be engraved, the edges of the reflecting surface of the pattern can be beveled, and the body of the pattern can be doped with impurities, foreign materials or air bubbles, or a metallic film can be provided on top of the reflecting surface of the pattern. The pattern is attached on the surface of one or more panels, or on to one another. LEDs are used as the light source to illuminate on the pattern. The LEDs are provided on a circuit board powered by an AC or DC power source or by a battery. The circuit board contains a drive circuit for driving the LEDs. The circuit board and the LEDs are positioned inside the housing along the edges of the housing or along the frame.

The illuminated sign of the present invention has two or more panels connected by a frame defining an enclosed space of the housing. A pattern made of a colored material or a light scattering/reflecting material is coupled onto a surface of one or more panels and positioned inside the housing. LEDs are provided inside the housing to illuminate the pattern.

The housing defined by the frame and the panels can be sealed against dust and insects, or against weather elements such as moisture. The panels are made of transparent material, so that a viewer can see through the sign of the present invention. The LEDs are mounted on a circuit board that includes a drive circuit for driving the LEDs. The circuit board is located inside the housing. In one embodiment, the circuit board is substantially perpendicular to the panels. There are many ways to design the panel and construct the housing. For example, the frame can be an integral part of one or more panels. In this case, two panels can directly mate together forming the housing without a separate frame.

To enhance light scattering effects, the pattern can be doped with impurities, foreign materials, or air bubbles, or coated with a metallic film. The surface of the pattern can be engraved. The edges of upper surface of the pattern can be beveled at an angle.

### BRIEF DESCRIPTION OF THE DRAWINGS

The above and other features and advantages of the present invention will become more apparent by describing in detail exemplary embodiments with reference to the attached drawings in which:

FIG. 1 is an exploded view of an illuminated sign according to one embodiment of the present invention.

FIG. 2 illustrates a panel with no pattern formed thereon of an illuminated sign according to one embodiment of the present invention.

FIG. 3 illustrates a panel with a pattern formed thereon of an illuminated sign according to one embodiment of the present invention.

FIGS. 4a and 4b are cross-sectional views of a letter or a pattern to be displayed in an illuminated sign according to the present invention.

FIG. 5 illustrates a frame of an illuminated sign according to one embodiment of the present invention.

FIG. 6 illustrates a LED circuit board of an illuminated sign according to one embodiment of the present invention.

### DETAILED DESCRIPTION OF THE EMBODIMENTS

The present invention will now be described with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

In the drawings, whenever the same element reappears in subsequent drawings, it is denoted by the same reference numeral.

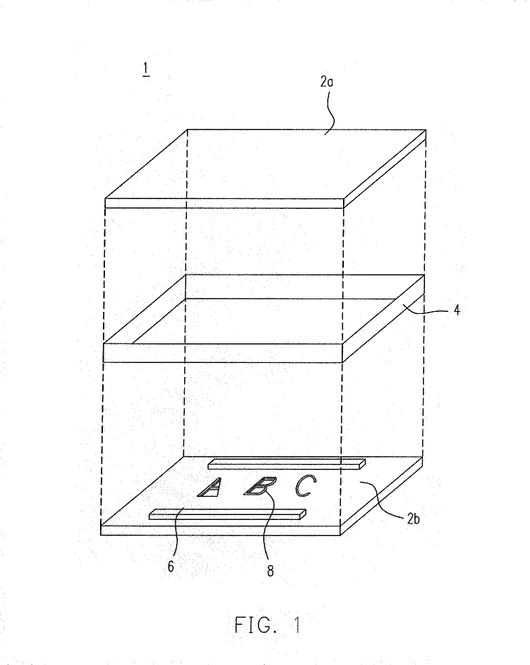

FIG. 1 is an exploded view of an illuminated sign 1 according to one embodiment of the present invention. The illuminated sign 1 includes a front panel 2a, a rear panel 2b and a frame 4 placed between the front panel 2a and the rear panel 2b. When assembled, the front panel 2a, the rear panel 2b and the frame 4 define an enclosed space for accommodating one or more LED circuit board 6 and a pattern 8 (See FIG. 3). The pattern 8 is made of colored and/or reflecting material and, when illuminated by LEDs on the LED circuit board 8, reflects or scatters light from the LEDs to generate a pleasant visual effect.

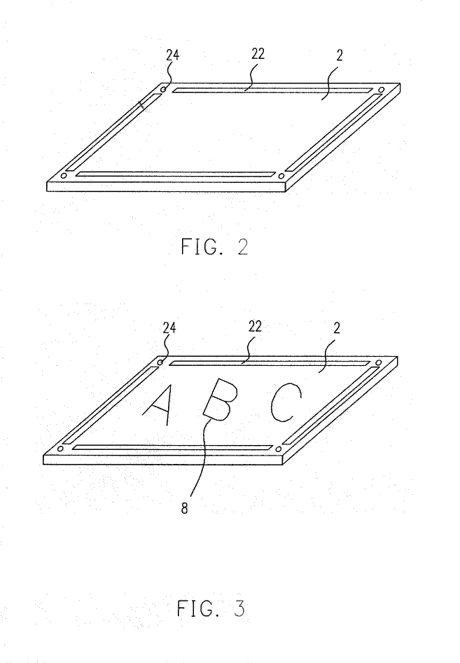

FIG. 2 shows a panel 2 of the illuminated sign according to one embodiment of the present invention. The panel 2 shown in FIG. 2 is a rectangular flat sheet. The panel 2 can also be made of other desired shapes or have a curved surface. Panel 2 is made of transparent or translucent plastic or glass material. Groove 22 is formed on the surface of panel 2 for positioning the LED circuit board 6. The edge of the LED circuit board 6 is inserted into the groove 22 and, if desired, fixed by glue. FIG. 2 shows four grooves 22 formed along the four edges of the rectangular panel 2 for receiving four corresponding LED circuit boards 6. The number and the location of groove 22 and LED circuit board 6 can be chosen according to specific design of the illuminating sign. A through hole 24 is formed on each corner of the rectangular panel 2 for receiving a screw.

FIG. 3 shows a panel 2 with a pattern 8 formed thereon. The pattern 8 can be a letter, a symbol, a logo, a figure, or a combination of the above, and is made of a color material, or light reflecting material, such as reflecting acrylic material or neon acrylic material with desired colors. As an example, the pattern 8 shown in FIG. 3 is three letters “ABC”. The pattern 8 may have the same color or have different colors at different parts. The pattern 8 is fixed by glue or mechanical means onto the surface of panel 2. If desirable, the pattern 8 can be positioned away from the surface of panel so as to be located in the middle of the enclosed space defined by panels 2 and frame 4. In this case, pins projected from the surface of panel 2 can be used to support pattern 8. Or pattern 8 can be mounted onto another pattern nearby so that pattern 8 is separated from either panel. Pattern 8 can be provided on one or both of panels 2a and 2b.

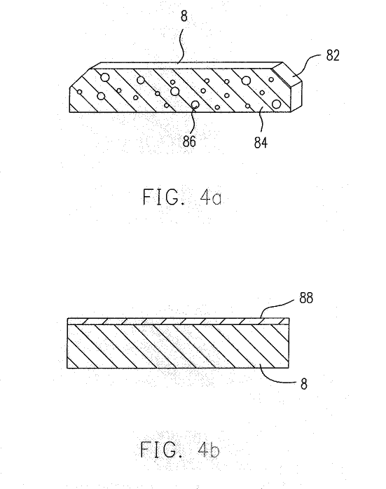

To enhance light scattering effects, the pattern 8 can be doped with impurities, foreign materials, or air bubbles, or coated with a metallic film. The surface of the pattern can be engraved. The edges of the upper surface of the pattern can be beveled at an angle or rounded. FIGS. 4a and 4b are enlarged cross-sectional views of pattern 8 such as a letter. FIG. 4a shows a beveled upper edge 82, air bubbles 86, and impurities 84. FIG. 4b shows a metallic film 88 formed on top surface of pattern 8.

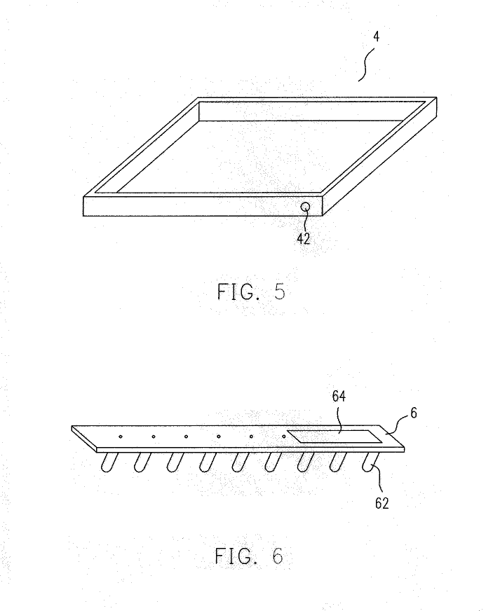

FIG. 5 shows a frame 4 which can be made of one piece or several pieces of plastic, metal, wood or other suitable materials. Frame 4 shown in FIG. 5 has four substantially perpendicular sidewalls. Two opposite sides of the sidewalls are connected to panel 2a and panel 2b, respectively, by glue or by mechanical means, so that an enclosed space is defined by panel 2a, panel 2b, and frame 4. Screws are used to fasten panel 2a and panel 2b against frame 4 through the through holes 24. LED circuit board 6 and pattern 8 are located within the enclosed space. A through hole 42 is provided on one sidewall of frame 4. A string is inserted through the through hole 42 for controlling the on/off switch of LEDs 62 located inside the enclosed space. Alternatively, an on/off switch button can be formed on the sidewall of frame 4.

Optionally, frame 4 can be replaced by inwardly projecting edges of panels 2a or 2b. The edges of a front or rear panel 2 can be bent inwardly so as to form an enclosure without a separate frame 4. The frame 4 can be made an integral part of the front or rear panel and is formed by inwardly projecting edges of the front or rear panel, or the frame may include a first portion and a second portion, the first portion is formed by inwardly projecting edges of the front panel and the second portion is formed by inwardly projecting edges of the rear panel.

FIG. 6 shows a LED circuit board 6. A plurality of LEDs 62 are mounted on LED circuit board 6. A control circuit 64 for driving the LEDs is provided on LED circuit board 6. Control circuit 64 can any suitable LED driving circuit. When assembled, one edge of LED circuit board 6 is engaged with groove 22 so as to be kept in position. LED circuit board can be glued to groove 22. In one embodiment, LED circuit board is substantially perpendicular to the surface of panels 2a and 2b with the LEDs 62 facing pattern 8, and four LED circuit boards 6 are provided, each having a length corresponding to the length of a corresponding groove 22, respectively. Control circuit 64 and LEDs 62 can be powered by an AC power source, a DC power source, or a battery controlled by an on/off switch.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An illuminated sign comprising:
a first panel;
a second panel;
a frame;
a pattern made of a colored material, a light scattering material, a light reflecting material, or a combination of the above in various color; and
one or more LEDs;
wherein the frame is positioned between the first panel and the second panel, so that the frame, the first panel, and the second together form a housing; the pattern is coupled to the first panel or the second panel and positioned inside the housing; and the LEDs are placed inside the housing to illuminate the pattern.

2. The illuminated sign of claim 1, wherein the housing formed by the frame, the first panel, and the second panel is sealed against dust and insects.

3. The illuminated sign of claim 1, wherein the first panel and the second panel are made of transparent material.

4. The illuminated sign of claim 1, wherein the LEDs are mounted on a circuit board that includes a drive circuit for driving the LEDs, and the circuit board is located inside the housing and positioned along edges of the housing.

5. The illuminated sign of claim 4, wherein the circuit board is substantially perpendicular to the first panel and the second panel.

6. The illuminated sign of claim 1, wherein a surface of the pattern is engraved.

7. The illuminated sign of claim 1, wherein the pattern is doped with impurities and/or foreign materials.

8. The illuminated sign of claim 1, wherein the pattern is doped with air bubbles.

9. The illuminated sign of claim 1, wherein the pattern is coated with a metallic film.

10. The illuminated sign of claim 1, wherein edges of upper surface of the pattern are beveled at an angle for better light scattering effects.

11. The illuminated sign of claim 1, wherein the frame is an integral part of the first panel and formed by inwardly projecting edges of the first panel.

12. The illuminated sign of claim 1, wherein the frame is an integral part of the second panel and formed by inwardly projecting edges of the second panel.

13. The illuminated sign of claim 1, wherein the frame includes a first portion and a second portion, the first portion is formed by inwardly projecting edges of the first panel and the second portion is formed by inwardly projecting edges of the second panel.

14. The illuminated sign of claim 1, wherein the pattern is made of reflecting acrylic material or neon acrylic material.

15. An illuminated sign comprising:
a first panel;
a second panel;
a third panel;
a frame;
a pattern made of a colored material, a light scattering material, a reflecting material, or a combination of the above in various color; and
one or more LEDs;
wherein the frame is placed between the first panel and the second panel, so that the frame, the first panel, and the second together define an enclosed space; the third panel is positioned between the first panel and the second panel inside the enclosed space, the pattern is coupled onto a first surface of the third panel; and the LEDs are placed inside the enclosed space to illuminate the pattern.

16. The illuminated sign of claim 15, further comprising another pattern coupled onto a second surface of the third panel which is opposite to the first surface.

17. The illuminated sign of claim 15, wherein the first panel and the second panel are made of transparent material.
